(19) United States
(12) Patent Application Publication
(10) Pub. No.: US 2023/0266208 A1
(43) Pub. Date: Aug. 24, 2023

(54) DIRECT DRIVE TISSUE HOMOGENIZER WITH DEBRIS SEPARATION CAPABILITY AND THE METHOD OF PREPARING A TISSUE SAMPLE

(71) Applicant: AROGI HEALTHCARE PTE LTD, Singapore (SG)

(72) Inventors: Chai Meng GOH, Singapore (SG); Guolin XU, Singapore (SG); Yi MAO, Singapore (SG); Hanchen WANG, Singapore (SG); Kai Xin NG, Singapore (SG); Xin YIN, Singapore (SG)

(21) Appl. No.: 18/010,070

(22) PCT Filed: Jun. 15, 2020
(86) PCT No.: PCT/SG2020/050334

§ 371 Date: Dec. 13, 2022

(51) Int. Cl. G01N 1/28

(52) U.S. Cl. CPC G01N 1/286; G01N 2001/2866

(57) ABSTRACT

A bio-sample homogenizer with a direct drive motor generating reciprocal motion for sample disruption, following continuous rotation for centrifuge tissue sample dissociation for debris separation. The homogenizer device comprises: a motor, a plurality of sample containers, a frame work to mount the sample containers. The direct drive motor generates constant acceleration/deceleration to drive the platform for producing a horizon reciprocal motion. A plurality of holding slots mounted on the framework for holding the plurality of sample containers containing with beads and tissue sample. The beads in the sample containers cause a blending action on the tissue sample for fully dissociation of the sample. Following continuous rotation generating centrifuge force, the finely dissociated solution is separated from the debris.

### FIELD OF THE INVENTION

The invention relates to tissue homogenizer for processing a sample of biological material, and in particular, a tissue homogenizer which prepares fully disrupted tissue sample first, following allows debris separation from the fully disrupted tissue sample continuously without any disruption.

### BACKGROUND OF THE INVENTION

Molecular diagnostics is dynamic and transformative. It leads to insights in research and treatment in many disease states that are revolutionizing health care. Molecular diagnostics detects and measures the presence of genetic material, including DNA, RNA or proteins that associate with a specific health condition or disease. Tissue sample is a commonly used bio-sample for preparing the genetic material for numerous applications, such as disease diagnostic and therapeutic, cancer research, biomarker research, drug development, etc.

There is a constant need for the development of simplified and high efficiency tissue sample preparation methods which is able to deliver high quality genetic material.

Processing of biological tissue sample is commonly accomplished by mechanical disruption of the tissue to obtain desired small piece of sample or even single cell, following these processed sample or cells are lysed by enzymatic digestion for DNA: RNA or protein extraction and purification. In general, the efficiency and effectiveness of enzymatic digestion are proportional to the surface area of the tissue-enzyme interface. Large surface area can be achieved by mincing the tissue by mechanical means prior to enzymatic exposure.

Some bio-samples, such as bacterial cell, fungi, yeast cell, spore, etc, have strong cell membranes which are very hard to break and are difficult to be processed. These samples have to be dissociated before DNA, RNA or protein extraction and purification.

US Publication No. 20060188892 discloses a kit for preserving DNA, RNA or producing a digested lysate of a tissue sample without homogenizing the sample. The kit requires the use of expensive enzyme chemical and a long incubation time under certain temperature e.g. 40 to 70° C. Suitable container comprising: a buffer; a catabolic enzyme; an ionic detergent and the tissue sample. The container requires complicated one, two or three-dimensional shaking. The maximum amount of tissue sample can be processed by the kit is rather small, only up to 10 mg only. Hence the kit is only suitable for small amount of sample applications, such as diagnosis applications.

Besides use of chemical reagents for tissue dissociation, mechanical force for tissue dissociation is also used. Mechanical force for tissue disassociation is faster than use of chemical reagents hence it is often preferred.

U.S. Pat. No. 7,611,840 discloses a device for sample tissue disruption and/or cell lysis comprising: a piezoelectric material; and at least a second material in contact with the piezoelectric material; the second material has an uneven surface on an opposite side to that in contact with the piezoelectric material, the uneven surface is brought about by a layer of silica beads and contacts a biological sample. The piezoelectric material is actuated by an external voltage source to generate cavitation, which disrupts tissue and/or lyses cells, in particular by a modulated alternative external voltage. The technology is able to process tissue sample in very short time.

Technologies in both US Publication No. 20060188892 and U.S. Pat. No. 7,611,840 have drawbacks, such as the device can only process small amount of sample. However, a large amount of tissue samples, e.g. a few hundred milligrams or even a few grams of sample have to be used for most research application. Although the process time for U.S. Pat. No. 7,611,840 is fast, but the technology cannot separate debris from the disassociated sample.

For using a large amount of tissue samples and reduce time required, U.S. Pat. No. 8,216,528 discloses a sample processing device which crushes a tissue sample to small size by crushing method. In this patent publication, a crushing tool comprises an inner crushing member and an outer side crushing member which is a tubular body capable of housing the inner crushing member therein. The device is configured such that a tissue sample (lymph node) is crushed to a predetermined size, by the inner crushing member of the crushing tool being repeatedly moved upward and downward while being rotated by a motor.

Similar to technology in U.S. Pat. Nos. 8,216,528, 10,173,220 discloses a tissue homogenizer which comprises a housing having a distal end and a proximal end, a cutting blade positioned at the distal end of the housing and a tissue actuator configured to be displaced along a longitudinal axis within the housing. The disadvantage of the homogenizer is that the structure is complicated and the cost is high.

Technologies in both U.S. Pat. Nos. 8,216,528 and 10,173,220 are able to process large amount of sample, but they are unable to separate wanted dissociated solution from unwanted debris.

Filter can be used for separating dissociated solution from debris. U.S. Pat. No. 7,270,284 B2 discloses a tissue homogenizer comprises a first chamber, a pair of blades, a first filter and a second filter. A tissue piece is placed between the first filter and the second filter cut by the blade, and moved by a fluid through the second filter to generate homogenized tissue pieces. The shortcomings of the homogenizer include complicated structure and the chamber of the homogenizer is not easy to be cleaned after use. Thus, cross-contamination of sample may occur. Finally, the tissue homogeniser is not suitable for use in preparing small amount of tissue sample.

Centrifugation also can be used for separating dissociated solution from debris. U.S. Pat. No. 9,962,717 discloses a system, a device and method for combined sample lysis/homogenization and centrifugation for debris separation. The device provides a clear lysate using automated sample grinding, homogenization and lysis of samples of biological and or geological origin, followed by a centrifugation step to clarify the supernatant from solid phase. Both operations (homogenization and centrifugation) are performed within the same sample container and instrument. However, the trajectories of the shaking motions or alternatively of two-dimensional projections of three-dimensional trajectories from using a rotor with swing out sample holders result in a huge amount of heat generated. The higher sample temperature may affect the biological samples for downstream application.

To reduce the temperature of sample during tissue dissociation, U.S. Pat. No. 9,556,410 discloses a homogenization process by employing a blender homogenizing tool with cooling means. The use of blender has many shortcomings, for example, the temperature of the tissue is elevated due to the heat generated by friction between the tissue and the homogenizing tool, or heat generated within the homogenizing tool occurs in the blender operation. There is concern that the proteins contained in the tissue will be thermally denatured when the temperature increases. DNA/RNA will be degraded when the temperature increases also. Therefore, it is suggested that the tissue is cooled within a test tube while being homogenized. There is a constant need for the development of simplified tissue sample preparation methods which deliver high quality and enriched tissue samples. Devices and methods that provide high quality tissue samples with little to no loss (physical or functional) are of interest.

The Inventors have observed a need in the art of sample preparation to have a means for a single step process, with a single piece of equipment and single vial, which may achieve both sample milling/grinding/homogenization/lysis and sample clarification/solid and liquid phase separation, without the process interrupted and without operator influence or intervention. Furthermore, with the increase of scarcity of available lab bench space, it would be beneficial to replace the two instruments commonly employed for lysis/homogenization and centrifugation with one single instrument to perform both functions.

The inventors have observed that the heat generated by the homogenizing devices of the prior art were due to forces generated in 1 Dimension and that a 2 Dimension Impact forces generated by using motion control for generating constant acceleration and deceleration would dissociate tissue sample more effectively.

The inventors have also observed that use of common beads for disassociation of bio-samples could further improve the disassociation process if constant acceleration/deceleration is applied as compared to the variable velocity and acceleration of normal rotary motor generated.

The invention therefore proposes a rotary motor which generates a 2-dimension force for disassociation of bio-sample tissue and then a continuous rotational centrifugation force to efficiently separate the debris and tissue sample. The inventive tissue homogenizer device offers all the benefits not attained by the prior art homogenizer devices.

The use of a rotary motor and a wheel-spoke design housing a plurality of bio-samples offers a low profile homogenizing device which may be readily placed on any table top or flat surface. The tube holders of bio-samples in the wheel-spoke design has a simple loading/unloading mechanism which allows easy fitting of tubes of bio-samples and equally easy removal of the same tubes of bio-samples from these tube holders.

This invention discloses a method and a device for rapid tissue homogenizer, which is capable of processing a large number of samples at one time. The inventive device uses a simple mechanical structure, takes a short processing time, low temperature increase, together with debris separation capability.

### SUMMARY OF THE INVENTION

A main object of the present invention is to provide a direct drive tissue homogenizer with debris separation capability, wherein a combination of dissociation and centrifugation for debris separation is obtained after a tissue sample is fully disrupted or minced.

Still another main object of the present invention is to provide a direct drive tissue homogenizer with debris separation capability, wherein the homogenizer generates a continuous and high 2 dimension impact force on the tissue sample, resulting a rapid sample disruption process.

Yet a further object of the present invention is to provide a direct drive tissue homogenizer with debris separation capability, wherein the homogenizer has simple structure and generates low heat and of low temperature, which is good for downstream DNA/RNA, protein process.

Still yet another main object of the present invention is to provide a direct drive tissue homogenizer with debris separation function for preparation of biological material. The homogenizer device comprises: a direct drive motor, a plurality of sample containers, a framework to mount the sample containers. The framework can be a solid bar, a circular solid plate or a circular hollow plate with plurality of arms. The sample container can be sphere, cube, cylinder or any other volumetric shapes that can contain a sample, a plurality of beads and liquid solutions. A plurality of holding slots mounted on the top surface of the framework, wherein the holding slots hold the sample containers; a direct drive motor having a rotating shaft being coupled to a center of a framework and the framework being rotatable about the shaft of the direct drive motor; wherein the direct drive motor generates a motion to the driving arms to produce a horizon motion for dissociation of the tissue in such a way that the beads in the tubular containers cause a blending action on the tissue.

Still another object of the present invention is to provide a direct drive tissue homogenizer with debris separation capability, wherein the motion generated by the direct drive motor is 20-60 degree reciprocal motion.

Another object of the present invention is to provide a direct drive tissue homogenizer with debris separation capability, wherein the motion generated has a constant acceleration, and the constant acceleration gives rise to a high impact force on the tissue.

A further yet another object of the present invention is to provide a direct drive tissue homogenizer with debris separation capability, further comprises a casing to encompass the drive motor and the framework having mounted with the plurality of container slots thereon.

Another further object of the present invention is to provide a direct drive tissue homogenizer with debris separation capability, wherein the casing is equipped with a control display for the operation of the homogenizer in preparing a tissue sample.

Still a further object of the present invention is to provide a direct drive tissue homogenizer with debris separation capability, wherein the tissue sample is being prepared within a time ranging from 10 seconds to 120 seconds, and the requirement of the tissue sample is controlled by the parameter setting on the control display.

Another further object of the present invention is to provide a direct drive tissue homogenizer with debris separation capability, wherein the beads in the containers are of different sizes together with a specific volume of buffer solution, and the size of the beads used is depending on the kind of tissue sample to be prepared.

Still another main object of the present invention is to provide a method of homogenizing a tissue using a motor driven homogenization device, the method comprises the steps of: supplying to a tubular container a raw material of biological tissue together buffer solution, wherein the container is equipped with a plurality of beads; operating the homogenization device to provide a reciprocating motion to the tubular container; reciprocating of the tubular container at angle of 20-60 degree for 30-120 second; forming a solution in the tubular container; stopping the reciprocating motion of the homogenizer; dividing finely the solution into a dispersion and a plurality of debris to be removed; and collecting the solution as a sample tissue solution.

Another object of the present invention is to provide a method of homogenizing using a direct drive homogenization device, wherein the reciprocating motion of the homogenization device is controlled at the control display on the casing of the homogenization device.

Yet a further object of the present invention is to provide a direct drive tissue homogenizer, wherein a tissue sample includes bacteria cell, fungi, yeast cell, and spore.

A further object of the present invention is to provide a direct drive tissue homogenizer with debris separation capability, wherein the holding slot on the framework holds the sample container by the action of snapping to the container.

It is an object of the present invention to provide a direct drive tissue homogenizer with debris separation capability, wherein the container is equipped with a chip with single or multiple wells.

Other objects and objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

FIG. 1 shows in perspective of a direct drive tissue homogenizer with debris separation capability in accordance with the present invention.

FIG. 2 schematically shows direct drive motor reciprocal rotating from 20-60 degree for dissociation of the tissue homogenizer in accordance with the present invention.

FIG. 3A, FIG. 3B and FIG. 3C shows the possible design of platform connect to the shaft of direct drive motor. Possible designs include but are not limited to these—solid plate platform, hollow platform with low inertia, single bar or multiple bar type of platform. A low inertia platform is preferred.

FIG. 4A, FIG. 4B FIG. 4C shows the possible shape of container used to contain the tissue sample. These includes but are not limited to—cylinder shape tube, cube shape tube, chip type of container with other reservoirs and channels and etc.

FIG. 5 shows the velocity and acceleration profile of sample container of the direct drive tissue homogenizer in accordance with the present invention, wherein the acceleration is constant and the impact force is high.

FIG. 6 shows 2D force generated by rotary motion control in accordance with the present invention, wherein the tissue dissociation is easy to implement.

FIG. 7 shows 20 to 60 degree reciprocal motion in the course of dissociation process in accordance with the present invention.

FIG. 8A shows an embodiment of continuous rotation after bio-sample dissociation of solution/beads and debris separation process in accordance with the present invention.

FIG. 8B shows another embodiment of continuous rotation after bio-sample dissociation of solution/beads and debris separation process in accordance with the present invention.

FIG. 9A shows a perspective view of the homogenizer in accordance with the present invention.

FIG. 9B indicates the cover of the homogenizer when the homogenizing operation is stopped and the cover being opened about the pivoting point in accordance with the present invention.

FIG. 10 shows schematically the control system for the homogenizer, including a touch screen control display for selecting the running parameters such as the speed, time and running cycles, a standalone driver with feedback control being used to drive the direct drive motor in accordance with the present invention.

FIG. 11A shows time required for fully dissociating of 100 to 400 mg of animal tissue samples in accordance with the present invention.

FIG. 11B shows time required for fully dissociating of 100 to 400 mg of different type of nut samples in accordance with the present invention.

FIG. 11C shows time required for fully dissociating different amount of plant samples in accordance with the present invention.

FIG. 11D shows temperature increase during processing of sample with liquid volume of 1.2 ml, 1.4 ml and 1.6 ml under continuous dissociation acceleration of 1000 rev/s² in accordance with the present invention, wherein the maximum temperature increase is only 7° C., which is means no cooling required.

### DETAILED DESCRIPTION OF PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

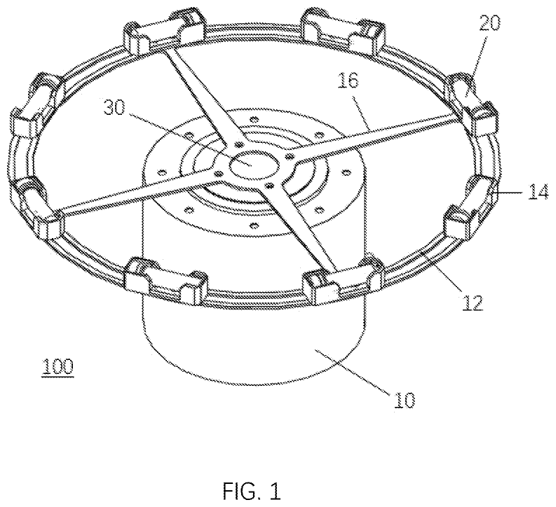

FIG. 1 is a perspective view of one embodiment of a direct drive tissue homogenizer with debris separation capability, designated as homogenizer (100). As shown in FIG. 1, the direct drive tissue homogenizer (100) with debris separation capability for preparation of biological material, comprises: a plurality of containers (20); a framework or a platform (12); a plurality of holding slots (14) mounted on the framework or the platform (12); and a direct drive motor (10) having a rotating shaft (30).

Each of the containers (20) contain a plurality of beads (22) of varying shapes and sizes. The type of beads (22) and the size of the beads (22) for each disassociation process by the homogenizer (100) depend on the nature of the bio-sample to be disassociated. The container (20) are filled with the beads (22) selected for each disassociation process and a certain volume of water would be then added. Finally a bio-sample of a defined weight is e introduced into the container (20).

Each of the holding slots (14) is spaced apart along the perimeter of the circular framework (12) or the platform, or the like such as a rotary wheel arrangement. Each holding slot (14) holds an individual tubular container (20) in place such that the axis of the containers (20) is in horizontal position, and the circular framework or the platform (12) is rotatable about the shaft (30) of the direct drive motor (10). Each holding slot (14) has a clamp and release mechanism to hold onto the tubular container (20) as the holding of the container (20) is s subjected to a large force as the container spun around at great velocity and at constant acceleration, based on this law of physics:

F (Force)=m (Mass)×a (Acceleration)

wherein F represents Force, m represents Mass and a represents Acceleration.

When the power of the direct drive motor (10) is switched on, the direct drive motor (10) generates a motion to rotate the shaft (30). A horizontal reciprocating motion is produced in the framework/platform (12). The beads (22) inside the tubular container (20) will cause dissociation process to the tissue (not shown) inside the container (20). The purpose of the beads (22) is for the blending action on the tissue. The direct drive motor (10) generates a motion to produce a horizontal reciprocating motion for dissociation of the tissue in such a way that the beads (22) in the tubular containers (20) cause a blending action on the tissue.

A low inertia platform is preferred for the present invention As in FIG. 1. Instead of using a solid platform, a hollow platform (wheel and spokes arrangement) may be used to reduce the weight of the platform. In such case, a circular framework (12) is used and is linked by a plurality of arms (16) to the shaft (30) of the direct drive motor (10).

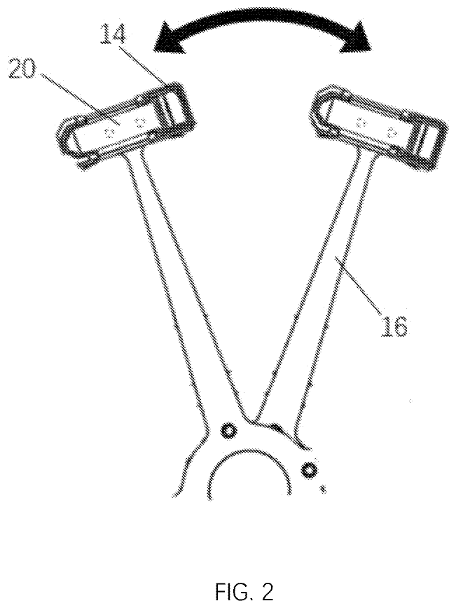

FIG. 2 schematically shows motion for dissociation of the tissue homogenizer (100) in accordance with the present invention. In the preferred embodiment of the present invention, the rotation of motion of the arms (16) from one position to another is preferably ranging from to 60 degree. The range of angle may even be extended to a range of 10-80 degree. In other words, the motion generated by the direct drive motor (10) is controlled to be in the range of 20-60 degree reciprocal motion, and preferably from 20-30 degree, as shown in FIG. 2. The motion generated by the direct drive motor (10) of the homogenizer (100) has a constant acceleration. This constant acceleration is applied to the container (20) containing the beads (22) of different sizes and bio-sample of different amount.

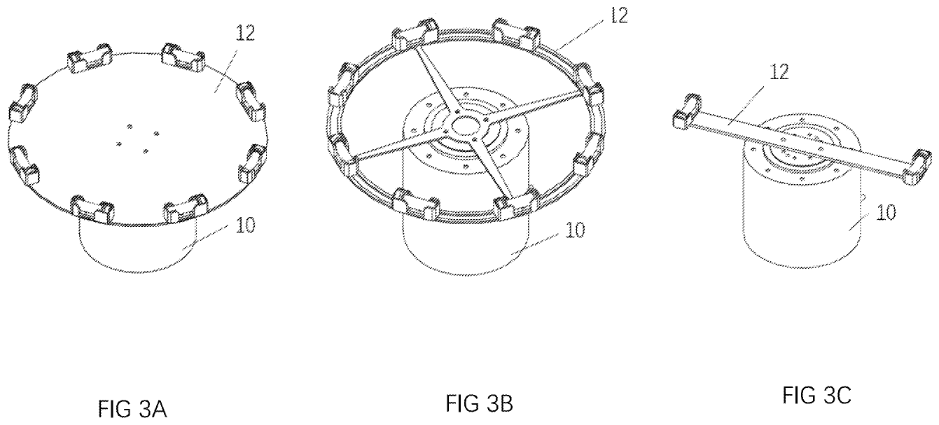

FIG. 3A to FIG. 3C show some preferred platform (12) used in the present invention. A low inertia platform is preferred for this application. When light weight materials, such as carbon fibre plate, light weight aluminium and etc, are used, the platform (12), as in FIG. 3A, may be a solid platform. If a hollow platform (as shown in FIG. 3B for reducing the initial of the platform, reducing the material used in the platform and consequently its weight also. For some applications, a bar type platform is prepared for cost effectiveness. The bar can be a single bar (as shown in FIG. 3C) or multiple bar (figure not shown).

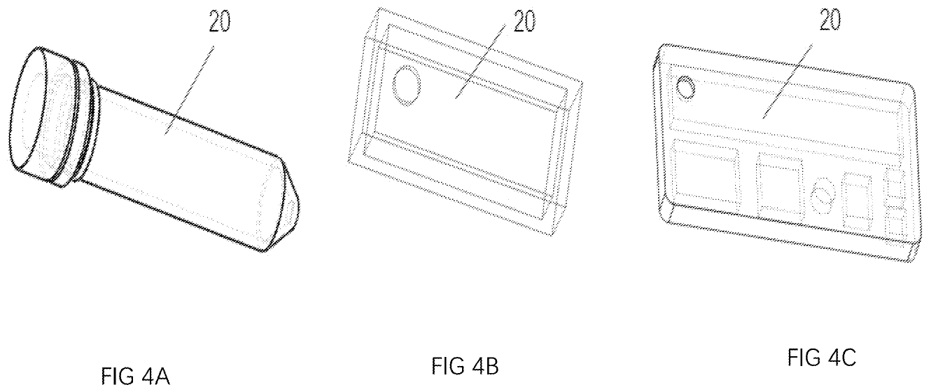

FIG. 4A to FIG. 4C show some preferred containers used in accordance with the present invention. The container can be formed of any shape as long as the container can be used to contain sample, the plurality of beads (22) and the reagents without leakage during tissue sample dissociation. The container (20) may be a cylinder or a cube. For some cylindrical container or cuboids, the container (20) may include a chip with single or multiple wells (as shown in FIG. 4C).

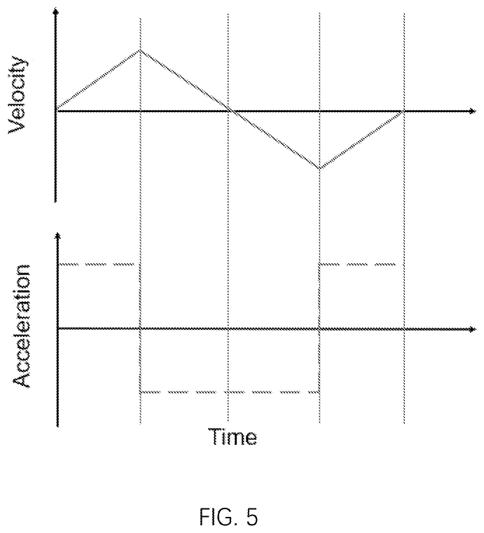

FIG. 5 shows the velocity and acceleration profile of the direct drive motor of the tissue homogenizer (100) in accordance with the present invention, wherein the acceleration is constant and the impact force is high. As shown in FIG. 3, due to the fact that the direct drive motor (10) generates a constant acceleration and deceleration to the container (20), the beads (22) in the container (20) exert a high impact force onto the tissue sample inside the container (20). The high impact force produces a fine mincing action on the bio-sample tissue and therefore, the dissociation process of the tissue is fine and quick. In the present invention, reciprocal motion of the direct drive motor (10) provides an effective tissue dissociation compared to that using a conventional rotary motor of the prior art. The motor of the homogeniser produces a reciprocal motion with a constant acceleration and deceleration which has a higher impact force on the tissue. The velocity and acceleration profile of a normal rotary motor used in homogenizers of the prior art and the velocity and constant acceleration/deceleration profile of the direct drive motor of the invention are therefore different.

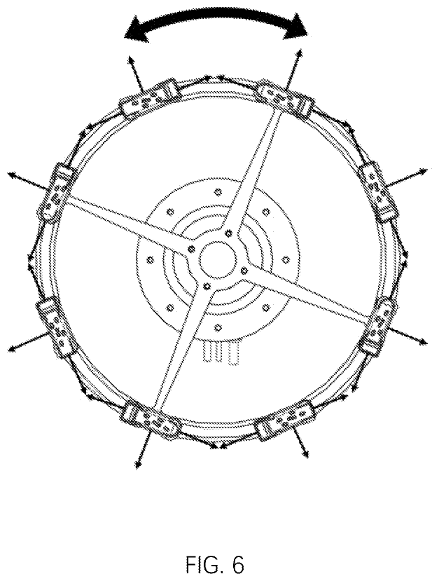

FIG. 6 shows 2D force generated by rotary motion generated by the direct drive motor in accordance with the present invention. The tissue dissociation process is easy to be implemented. The force generated by the reciprocal motion of the circular framework (12) is a 2D force, which is able to dissociate tissue sample more effectively, and the tissue dissociation is easy to achieve in the present invention. Further less heat is produced in the disassociation process of the present invention.

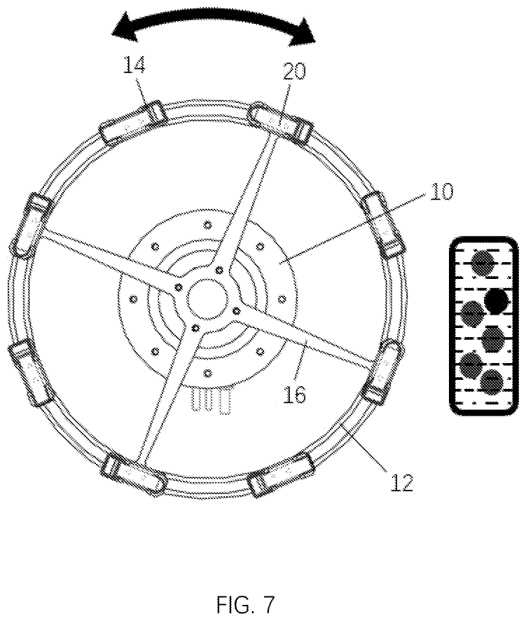

FIG. 7 shows schematically a motion of 20 to 60 degrees of the homogenizer (100) in the course of dissociation process in accordance with the present invention.

The present invention also relates to a method of preparing homogenized tissue sample using a direct drive motor driven homogenizer (100). The method comprises the steps of: supplying to a container (20) a raw material of biological tissue together with a buffer solution and beads (22); operating the homogenizer to provide a reciprocating motion to the container; reciprocating of the container at angle of ranging from 20-60 degree for a time ranging from 30-120 seconds; forming a solution with biological tissue in the container; stopping the reciprocating motion of the homogenizer; dividing finely the solution into a dispersion and a plurality of debris to be removed; and collecting the solution as a sample tissue solution.

In the preferred embodiment of the present invention, the container (20) is fitted onto the holding slot spaced along the perimeter of the framework. The container filled with beads (22) and buffer solution is then secured onto the circular framework. The direct drive motor of the homogenizer (100) is switched on to provide a reciprocating motion to the tubular container (20). The container is undergone a reciprocating motion at a range of 20-60 degree for 30-120 second. The contents of the bio-sample, and buffer solution form solution in the tubular container (20).

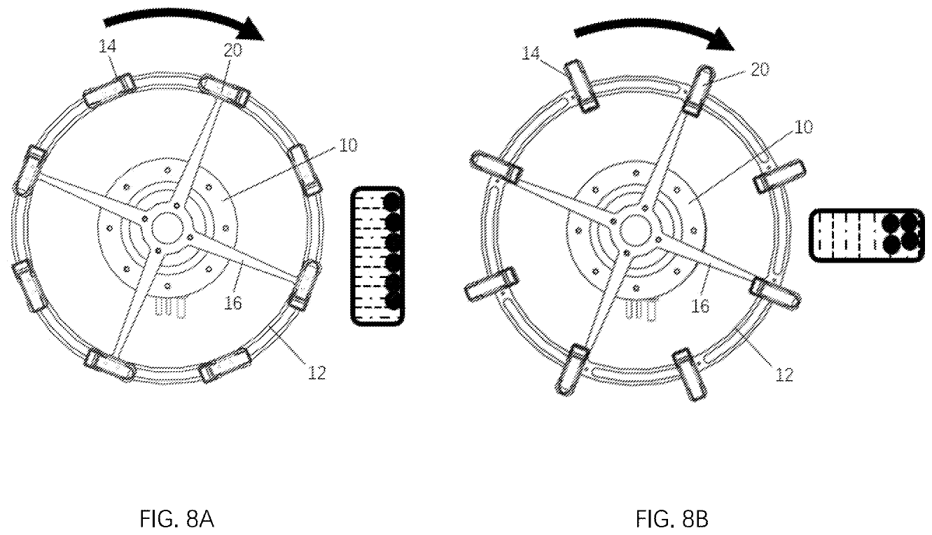

FIG. 8A and FIG. 8B show continuous rotation after dissociation process for dissociated solution/beads for separation of the bio-sample and debris (including the beads) in accordance with the present homogenizer (100). After reciprocating of the container (20) at an angle of 20-60 degree for 30-120 second, continuous rotation will be carried out for 30-120 second to separate the dissociated solution from the debris (e.g. not dissociated hard tissue and the beads). The debris is then removed and the solution is then collected as a sample tissue solution.

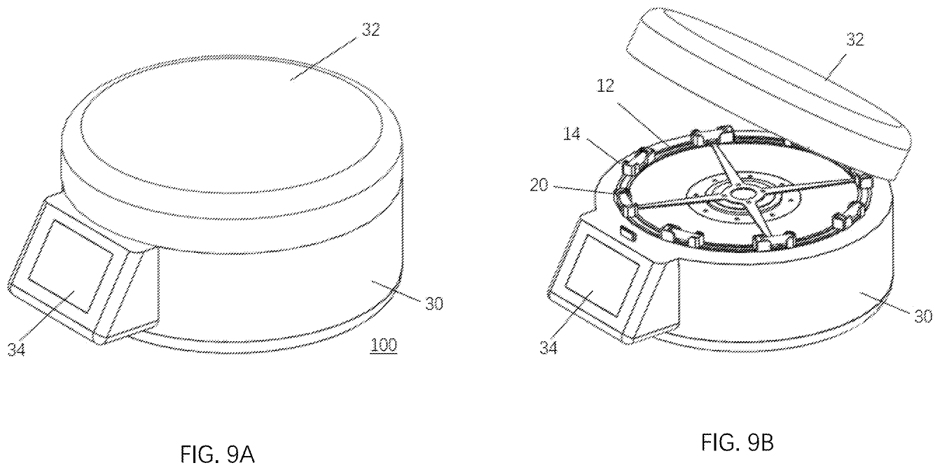

FIG. 9A shows a perspective view of the homogenizer (100) in accordance with the present invention.

In another preferred embodiment of the present invention, the direct drive homogenizer (100) further comprises a casing (30) to encompass the drive motor (10) and the circular framework (12) having mounted with the plurality of holding slots (14) thereon. The casing (30) is equipped with a control display (34) for the operation of the homogenizer (100) in preparing a tissue sample. The tissue sample is being prepared within a period of time ranging from 30 seconds to 120 seconds of reciprocating motion generated by the direct drive motor (10). There are a plurality of parameters, such as speed, time cycle, etc on the control display (34) to operate the homogenizer (100) and the parameters that are used to prepare a tissue sample are largely based on the requirements for the tissue sample.

To prepare a tissue sample, the container (20) is filled with a plurality of beads (22), which are of different sizes together with a specific volume of buffer solution. The size of the beads (22) used depend greatly on the kind of tissue to be prepared. After a tissue sample in a container (20) is placed into the holding slot (14), the operational parameters, such as number of cycles, speed and time are set. The user would then start the homogeniser which would begin a reciprocating motion of the homogenizer (100). The operations of the homogenizer are controlled at the control display (34) on the casing (30) of the homogenizer (100). The holding slot (14) on the rotary wheel spoke framework (12) holds the container (20) by the action of snapping to the container (20).

The direct drive tissue homogenizer (100) of the present invention can be used to prepare tissue samples, bacteria cell, fungi, yeast cell, and spore. The container (20) can be a standard test tube like structure equipped with an opening and a cap (24) to seal the opening of the tube. The container (20) would be filled with a plurality beads (22) of different sizes (appropriate to the type of tissue to be disassociated) and a certain volume of reagent such as Phosphate Buffered Saline (PBS) or other type of solution.

FIG. 9A is a perspective view showing an outer view of a homogenizer (100) with a casing (30) according to the present embodiment. A homogenizer (100) according to the present embodiment is an apparatus that is compact and low-profile design with a control display (34) facilitating easy operation. There is a cover (32) which covers the rotary wheel spoke framework (12) in the course of preparing tissue samples. The requisite requirements for preparing the tissue sample are set using the control display (34) built on the casing (30). The homogenizer (100) is substantially circular shape, low profile structure and the round cover (32) is pivotally mounted to the casing (30). When dissociation process is in progress, the cover (32) has to be securely closed.

FIG. 9B shows the cover (32) of the homogenizer (100) released in an opened position after the dissociation process is completed. The cover (32) is opened about the pivoting point on the casing (30).

Again referring to FIG. 9B, after the homogenizer (100) has completed the disassociation and separation process, the cover (32) is lifted into an open position. The tubular containers (20) would be removed from the container holding slots spaced along the circular framework or rotary wheel spoke arrangement. The original mixture of beads, water and bio-tissue sample in each container (20) now would have been clearly separated from the solution. The solution is then collected for further scientific analysis or testing. The debris (including the beads) would be safely disposed.

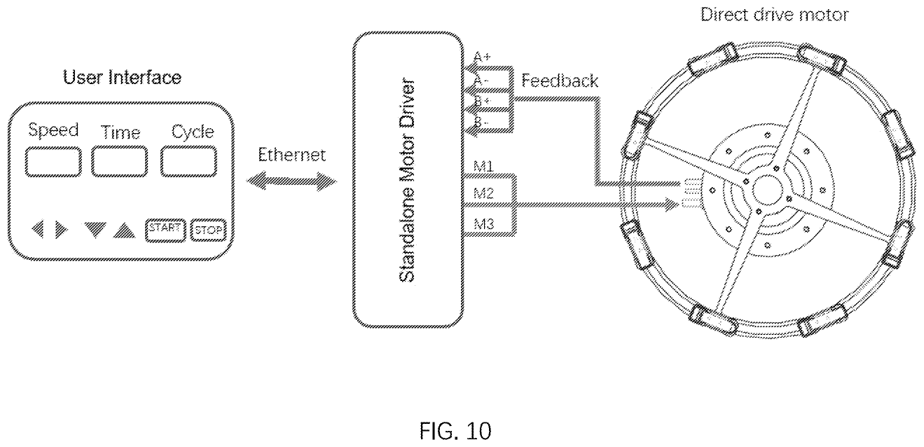

FIG. 10 shows the main parts of the homogenizer (100) of the invention as shown in FIG. 9B. The homogeniser comprises of a casing (30), with a direct drive motor (10) and a framework with a plurality of container holding slots spaced along the perimeter of the framework (12). The framework (12) may also be described as an arrangement of a rotary wheel with spokes emanating from the centre and supporting the perimeter structure. Each container holding slot is equipped with a clamp and release mechanism to hold onto the tubular container as the tubular containers are rotated at high acceleration during the disassociation process. The homogenizer has electronic data processing unit with memory which enables it to record and store data obtained in the disassociation process for improved processing.

An user interface in the form of a Display Panel allows an user to set operating parameters such as speed, time of operation and number of cycles. The homogenizer therefore has hardware and software for operational control of the motor including speed, time of operations and number of cycles and so on. The homogeniser may be linked by local networks to computers located outside the laboratory for operational reasons. Operational data such as type of bio-sample tissue to be prepared may be collected and fed back into the homogeniser for more precise operations. The display panel would also have “Start” and “Stop” indicators as well as arrows to move the rotary motor and wheel spoke configuration in increments. Below the rotary motor and wheel spoke configuration is the standalone direct drive Motor. The said framework is mounted on the direct drive motor.

As shown in FIG. 10, longer timing of reciprocating motion by the homogenizer (100) is needed if the tissue sample is too hard to be prepared within 30 seconds. The homogenizer (100) will work for a longer time period, for example 30 seconds, then stop for a period time, for example second as 1 cycle. Amount of running cycles will be set on the control display (34) by the user.

Data collected from past operations of the homogenizer would be used to refine the parameters for preparing each type of bio-sample to be disassociated.

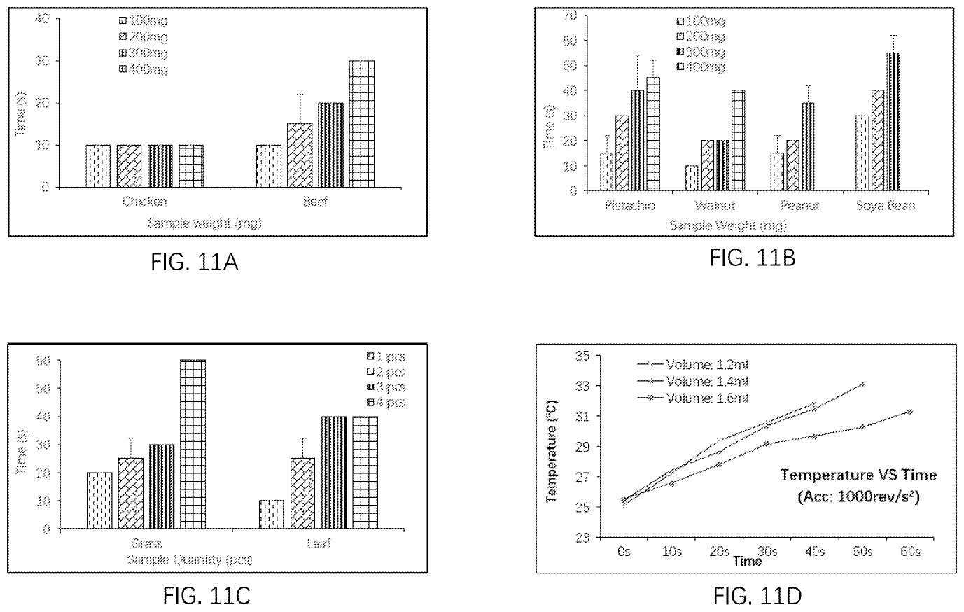

FIG. 11A to 11C show time required for dissociating different amount of meat, nuts, grass and leaf. Dissociating process can be done within 60 s for all types of biological samples and different weights of bio-samples. FIG. 10B shows that even for nuts of different types which are typically difficult to disassociate, the time taken to process 300 mg of pistachio, walnut and peanut and soya bean using the homogenizer of the invention is relatively short—being 40 s, s, 36 s and 55 s respectively.

FIG. 11D shows the temperature increase during processing of sample with liquid volume of 1.2 ml, 1.4 ml and 1.6 ml under continuous dissociation acceleration of 1000 rev/s². The maximum temperature increase is only 8° C. (from 25° C. to 33° C.). Such a low temperature increase means DNA/RNA, protein and other bio-targets will not be affected by the use of homogenizer of the invention. Further more use of the homogenizer of the invention shows that no cooling step is required during sample dissociating process, which would complicate the disassociation and separation process as well as lengthen the entire process to obtain the bio-samples.

### Advantageous Effects of the Invention

The homogenizer of the present invention through a single operation is able to achieve both sample milling/grinding/homogenization/lysis and sample clarification/solid and liquid phase separation, without the process being interrupted and without operator influence or intervention.

The homogenizer of the invention also dissociates large tissue samples more effectively and without the adverse effect of too much heat generated during its operation, which would affect the bio-samples for downstream DNA/RNA and protein process. The outcome is simplified tissue sample preparation process which deliver high quality and enriched tissue samples with little to no loss (physical or functional) to the bio-samples.

The inventive device uses a simple mechanical structure, takes a short processing time, low temperature increase, together with debris separation capability. As the inventive device is equipped with hardware and software for programming and storage of parameters for disassociation and separation of different types of bio-samples, and capability for connection to a network, the homogenizer would be more efficient and superior to the homogenizers currently in use.

The foregoing discussion of the invention and different aspects thereof has been presented for purposes of illustration and description. The foregoing is not intended to limit the invention to only the form or forms specifically disclosed herein. Consequently, variations and modifications commensurate with the above teachings, and the skill or knowledge of the relevant art, are within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A direct drive tissue homogenizer with debris separation capability for preparation of biological tissue sample, the homogenizer comprising:
a plurality of containers each of which accommodates a plurality of beads, wherein the containers contain a tissue sample together with a buffer solution;
a circular framework which is rotatable and being rotatably mounted;
a plurality of holding slots mounted on the framework, wherein the holding slots hold the tubular containers and the axis of the containers is in horizontal position;
a direct drive motor having a rotating shaft being coupled to the center of the framework and the framework rotating about the shaft of the direct drive motor; thereby the drive motor generates a reciprocal motion to drive the frame work to produce a horizon motion for dissociation process of the tissue sample in such a way that the beads in the tubular containers cause a blending action on the tissue sample.

2. The direct drive tissue homogenizer as set forth in claim 1, wherein the reciprocal motion generated by the direct drive motor is in a range of 20-60 degree reciprocal motion.

3. The direct drive tissue homogenizer as set forth in claim 2, wherein the reciprocal motion generated has a constant acceleration and deceleration.

4. The direct drive tissue homogenizer as set forth in claim 1, further comprising a casing to encompass the drive motor and the circular framework having mounted with the plurality of holding slots thereon.

5. The direct drive tissue homogenizer as set forth in claim 5, wherein the casing is equipped with a control display for the operation of the homogenizer in preparing the tissue sample.

6. The direct drive tissue homogenizer as set forth in claim 5, wherein the tissue sample is being prepared within a time ranging from 30 seconds to 120 seconds in a reciprocating motion.

7. The direct drive tissue homogenizer as set forth in claim 5, wherein a plurality of parameters are set on the control display depending on requirement of the tissue sample.

8. The direct drive tissue homogenizer as set forth in claim 7, wherein the plurality of parameters includes speed, time and cycle.

9. The direct drive tissue homogenizer as set forth in claim 1, wherein the container is provided with an opening and a cap for capping the opening, and said container contains the plurality of beads and a raw material of biological tissue together with a portion of buffer solution without leakage.

10. The direct drive tissue homogenizer as set forth in claim 1, wherein the beads in the containers are of different sizes together with the buffer solution, and the size of the beads used is depending on the kind of tissue used.

11. A method of homogenizing of tissue sample using a direct drive homogenizer set forth in claim 1, comprising the steps of:
supplying to a tubular container a raw material of biological tissue together with a portion of buffer solution, wherein the container contains a plurality of beads;
operating the homogenizer to provide a reciprocating motion to the container;
reciprocating of the container at angle of ranging from 20-60 degree for a time ranging from 30-120 seconds;
forming a solution with biological tissue in the container;
stopping the reciprocating motion of the homogenizer;
dividing finely the solution into a dispersion and a plurality of debris to be removed; and
collecting the solution as a sample tissue solution.

12. The method of homogenizing using a direct drive homogenizer as set forth in claim 11, wherein the reciprocating motion of the homogenizer is controlled at the control display on the casing of the homogenizer.

13. The method of homogenizing using a direct drive homogenizer as set forth in claim 11, wherein both sample milling/grinding/homogenization/lysis and sample clarification/solid and liquid phase separation is obtained without any interruption.

14. The method of homogenizing using a direct drive homogenizer as set forth in claim 11, wherein the steps are effective in processing a tissue including bacteria cell sample, fungi, yeast cell, spore and bio-samples.

15. The direct drive tissue homogenizer as set forth in claim 1, further comprising an electronic data processing unit equipped with memory for recording and storing data obtained in the dissociation process so as to improve subsequent processing for a sample.

16. The direct drive tissue homogenizer as set forth in claim 15, wherein a user interface is provided to the control display, allowing an user to set operating parameters to the homogenizer.

17. The direct drive tissue homogenizer as set forth in claim 15, wherein a software application is provided to the homogenizer for operational control of the motor of the homogenizer.

18. The direct drive tissue homogenizer as set forth in claim 17, wherein the software application is used to control the speed, time of operation and the number of cycle of the motor of the homogenizer.

19. The direct drive tissue homogenizer as set forth in claim 1, wherein a tissue sample includes bacteria cell, fungi, yeast cell, spore and other bio-samples.

20. The direct drive tissue homogenizer as set forth in claim 1, wherein the holding slot on the framework holds the tubular container by the action of snapping onto the container.

21. The direct drive tissue homogenizer as set forth in claim 1, wherein the container is varied to any shape to contain the biological sample, the plurality of beads (22) and a reagent without leakage in the course of dissociation process of the biological sample.

22. The direct drive tissue homogenizer as set forth in claim 21, wherein the container is cylindrical shape or a cuboid.

23. The direct drive tissue homogenizer as set forth in claim 1, wherein the container is equipped with a chip with single or multiple wells.

24. The direct drive tissue homogenizer as set forth in claim 1, wherein the framework can be in a form of a platform (12) of low inertia formed from a light weight materials, such as carbon fibre plate, light weight aluminium.

25. The direct drive tissue homogenizer as set forth in claim 24, wherein the framework is a solid platform or a bar type platform.

26. The direct drive tissue homogenizer as set forth in claim 25, wherein the bar type platform is a single bar or a multiple bars.

27. The direct drive tissue homogenizer as set forth in claim 11, wherein the buffer solution is phosphate buffered saline (PBS).
